(19) United States
(12) Patent Application Publication
(10) Pub. No.: US 2013/0231953 A1
(43) Pub. Date: Sep. 5, 2013

(54) METHOD, SYSTEM AND COMPUTER PROGRAM PRODUCT FOR AGGREGATING POPULATION DATA

(71) Applicants: Shahram Ebadollahi, White Plains, NY (US); Jianying HU, Bronx, NY (US); Jimeng Sun, White Plains, NY (US); Robert K. Sorrentino, Briarcliff Manor, NY (US)

(72) Inventors: Shahram Ebadollahi, White Plains, NY (US); Jianying HU, Bronx, NY (US); Jimeng Sun, White Plains, NY (US); Robert K. Sorrentino, Briarcliff Manor, NY (US)

(21) Appl. No.: 13/409,890

(22) Filed: Mar. 1, 2012

(51) Int. Cl. G06Q 50/24; G06Q 30/02

(52) U.S. Cl. 705/3; 705/7.29

(57) ABSTRACT

A system, method and program product for matching members of a population, e.g., patients, based on member similarities. Patients are mapped to a bipartite graph with patient nodes connected by weighted edges to clustered factor nodes, are clustered categorically. As a new patient query is received, a similarity measure for each other patient is generated for each cluster by comparing cluster edges. The cluster similarity measures are aggregated for each patient to provide a global closeness measure to every other patient. Based on the global closeness measure, a list of the closest patients is displayed and measurement feedback may be provided.

### BACKGROUND OF THE INVENTION

1. Field of the Invention

The present invention is related to aggregating population data according to member similarity and more particularly to aggregating electronic health records from multiple data sources based on patient similarities.

2. Background Description

Healthcare digitization has produced voluminous data. Doctor's offices, that have been converting paper patient records to electronic records, collect new patient data in an electronic format, e.g., as electronic health records (EHR). EHRs make patient histories readily available, e.g., for making/supporting clinical decisions. Existing EHR data can facilitate subsequent patient diagnosis and treatment. Matching new patient symptoms and other characteristics to patient histories to find patients with similar symptoms and characteristics, may provide the patient's doctor with an early diagnosis and suggest treatment. At the very least, it will winnow the potential diagnosis and treatment to a few likely diagnoses and treatments. However, while multiple patients may have the same diagnosis, no two people are identical, e.g., symptoms and treatment may be different. Thus typically, complete matches are infrequent.

While finding complete matches in the voluminous, multi-dimensional data may be a relatively simple task, defining and finding similar cases can be much more complicated. The degree of similarity desired, for example, can complicate matching similar patient histories. Further, having been collected by multiple health care providers in different formats, the raw history data may be in multiple locations in different databases/sources in multiple incompatible formats. The data formats may include, for example, International Classification of Diseases, Ninth Revision (ICD9), Current Procedural Terminology (CPT) codes, National Drug Codes (NDC), LAB, clinical notes. These formats rely heavily on coding the data both to quickly categorize it and for efficient data handling.

However, the variety and variation of these codes can complicate comparing data further. Typically there isn't a one to one mapping for codes, making it more difficult to: value the relevance of the raw data, determine event timeliness, and determine for each match what coded events are more important than others. Missing data or mismatched codes may mask similarities. Noise, e.g., unrelated symptoms, in the raw data can further shade results. Moreover, once similar results are matched, those results are not an ultimate determination. That, typically, is made by a requesting physician. Currently, there is no mechanism that allows the requesting physician to provide similarity goodness feedback based on his/her clinical intuition used to make a final diagnosis and prescribe an appropriate treatment.

Thus, there is a need for a way to identify similarities in patient histories and aggregate the results to reflect a global similarity.

### SUMMARY OF THE INVENTION

A feature of the invention is a similarity measure for grouping members of a population based on member similarities;

Another feature of the invention is improved matching of medical patients with similar conditions based on patient similarities;

Another feature of the invention is improving matching of medical patients with similar conditions based on feedback from medical professionals with regard to previous grouping;

Yet another feature of the invention is a similarity measure for matching medical patients based on patient similarities, and further honed by feedback from medical professionals with regard to previous grouping.

The present invention relates to a system, method and program product for matching members of a population, e.g., patients, based on member similarities. Patients are mapped to a bipartite graph with patient nodes connected by weighted edges to clustered factor nodes, are clustered categorically. As a new patient query is received, a similarity measure for each other patient is generated for each cluster by comparing cluster edges. The cluster similarity measures are aggregated for each patient to provide a global closeness measure to every other patient. Based on the global closeness measure, a list of the closest patients is displayed and measurement feedback may be provided.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows an example of a system for matching patients to other patients based on patient similarities according to a preferred embodiment of the present invention;

FIG. 2 shows an example of matching a patient to existing patients according to a preferred embodiment of the present invention;

FIG. 3 shows an example of the similarity measurement module graphically modeling patient data as patient nodes connected by edges to factor nodes, grouped or clustered.

### DESCRIPTION OF PREFERRED EMBODIMENTS

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

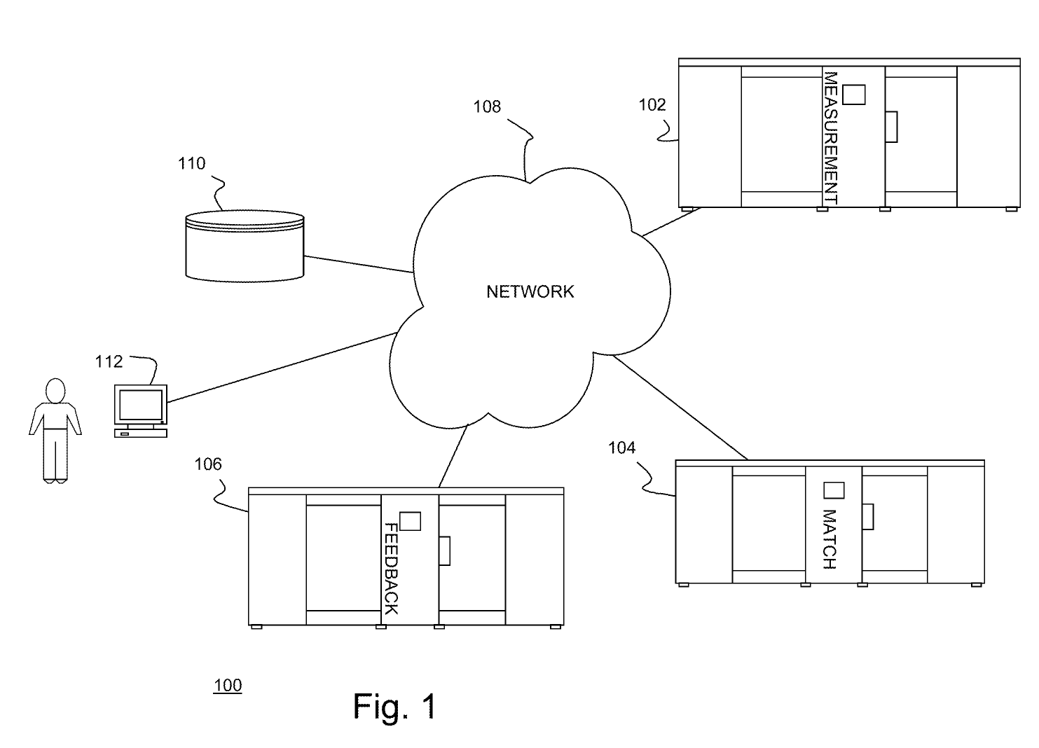

Turning now to the drawings and, more particularly, FIG. 1 shows an example of a system 100 for matching patients to other patients based on patient similarities according to a preferred embodiment of the present invention. In this example, a similarity measurement module 102, similarity match module 104 and feedback module 106 are located, for example only, on multiple individual computers networked together over a network 108. The individual computers may be located at a single location or distrusted at remote locations. Further, one, two or all of the preferred modules 102, 104, 106 may be collocated on a single computer. Although described in terms of medical data, databases and patients, the present invention has application to aggregating individuals, human or otherwise, in any population of any type (e.g., a fleet of cars, ships or aircraft) according to similarities.

The similarity measurement module 102 determines a pairwise patient similarity score for a current patient against histories, e.g., in storage 110, for other individual patients to identify similar conditions. In particular, the similarity measurement module 102 uses a general patient similarity measure for handling heterogeneous patient records as set forth hereinbelow. The similarity match module 104 searches resulting similarity scores and retrieves the histories for the top-k similar scores. The top-k similar scores are returned, e.g., displayed 112, for a medical professional, e.g., a doctor to select one or more similar patients and make a diagnosis for the current patient and suggest treatment. The feedback module 106 receives general patient similarity measure incorporating feedback from experts, e.g., the efficacy of the treatment selected, to further customize and hone the similarity match performed by the similarity measurement module 102.

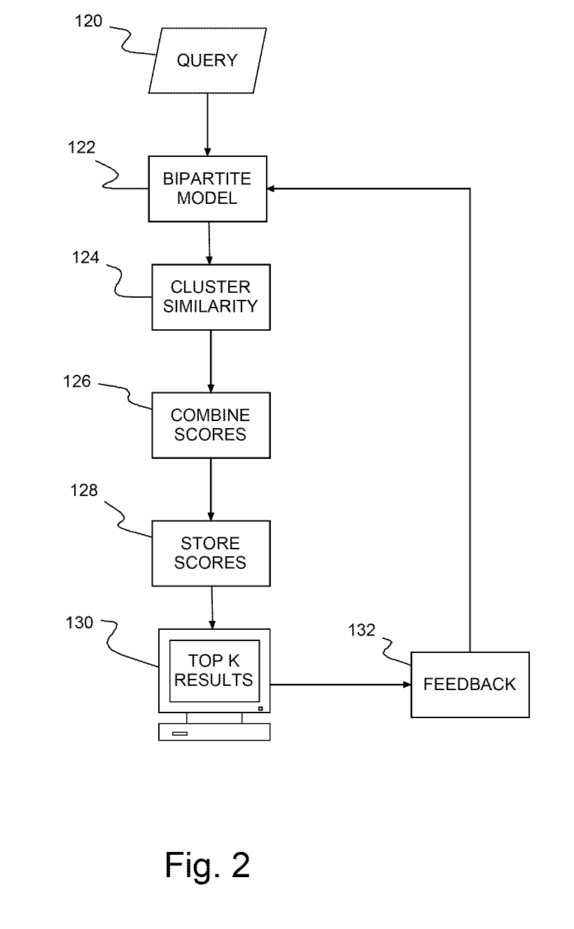

FIG. 2 shows an example of matching a patient to existing patients according to a preferred embodiment of the present invention. When a preferred system (e.g., 100 in FIG. 1) receives a query 120 about a patient, the similarity measurement module 102 models 122 patient data as a bipartite graph with two types of nodes, patient and clustered factor nodes connected by edges. Then, the similarity measurement module 102 determines a cluster similarity score 124 for each other patient in each factor cluster. The similarity measurement module 102 combines scores 126 for each patient to provide a global similarity measure for each. The similarity measurement module 102 stores 128 the results, which indicate how close each other patient matches the query patient. Optionally, only a selected number of the closest matches are stored, e.g., based on the highest global scores for each other patient. The similarity match module 104 searches the stored similarity scores, retrieves the top-k similar scores and presents 130 histories for those top-k patients. The requesting medical professional, e.g., the query patient's doctor, reviews the results, e.g., on display 112 using a typical graphical user interface (GUI). The requesting medical professional can review the results and provide feedback 132 to feedback module 106 through the GUI, which the feedback module 106 uses to re-weight the graph edges.

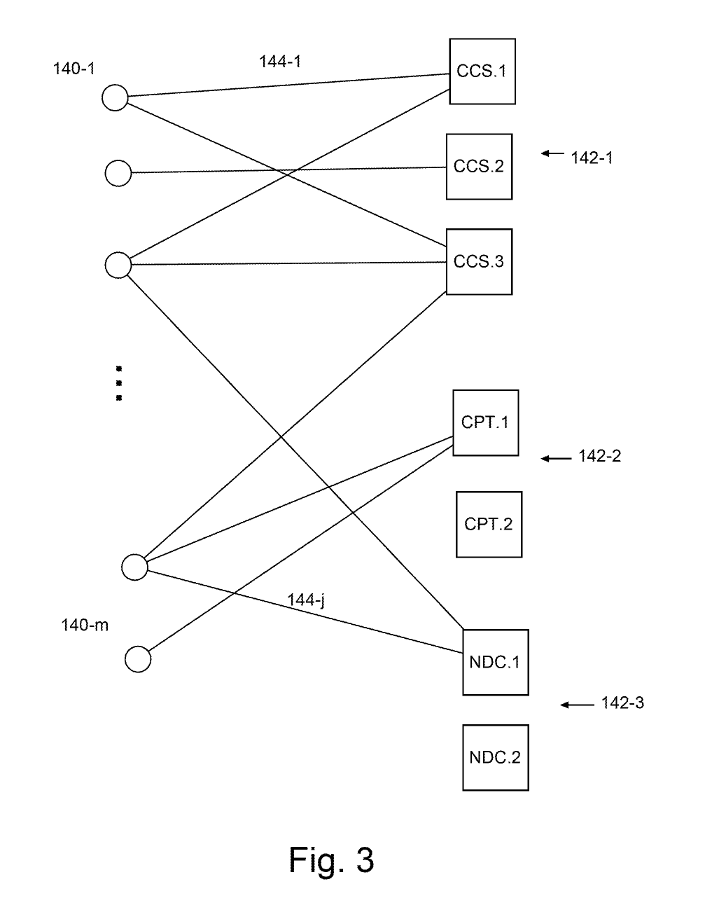

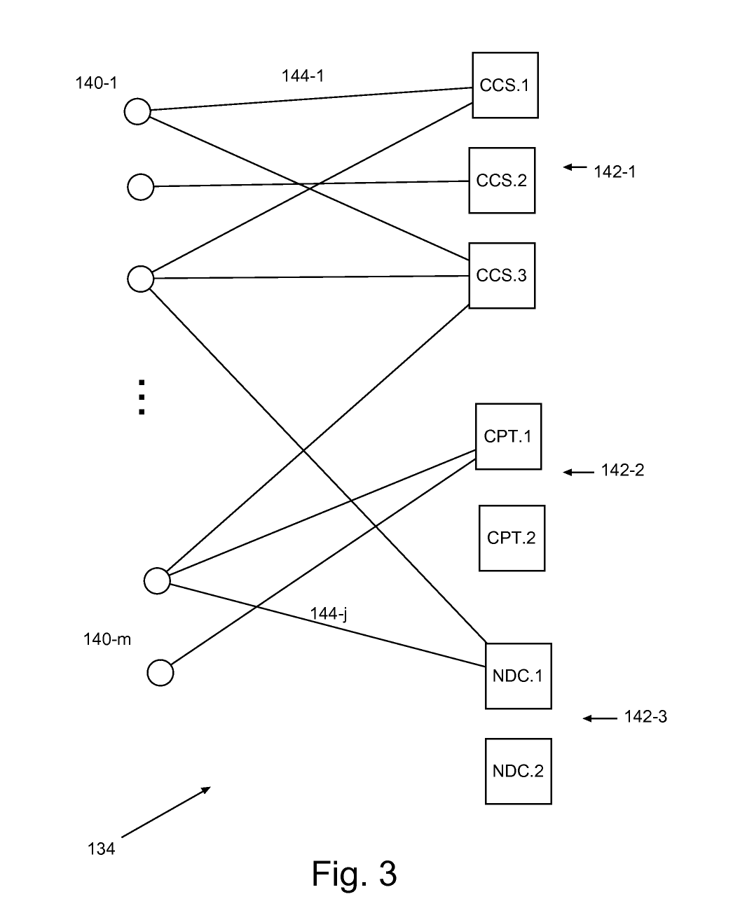

So, as shown in the example of FIG. 3, the similarity measurement module 102 models (120 in FIG. 2) patient data as a bipartite graph with two types of nodes, patient nodes 140-1-140-m and factor nodes, grouped or clustered in clusters 142-1-142-n, where n=three (3) in this example. The patient nodes 140-1-140-m correspond to individual patients. Each factor cluster 142-1-142-n may be weighted w and is associated a particular feature, e.g., patient codes. The clusters 142-1-142-n can have multiple types with each type associated with a different type weight tᵢ. Relationships between the patients and individual cluster nodes are indicated by edges 144-1-144-j. Weights a, associated with each of the edges 144-1-144-j, indicate the importance of each particular relationship.

The similarity measurement module 102 determines 124 a cluster similarity score, s₁, s₂, . . . , sₙ, for each new or requesting patient x with each other patient y, i.e., nodes 140-1-140-m, in each factor cluster 142-1-142-n. For example, if two patients x and y connect to a common factor f, the match result between x and y on f is 1; and otherwise f is 0, i.e., no match. This match result can be generalized to be weighted by wₓ*w_{y}*t where wₓ, w_{y} are the edge weights from x or y to f, and t is the type weight of f. A general example of determining a similarity measure between members of a population based on connection to members of another population is described by J. Sun et al., “Neighborhood Formation and Anomaly Detection in Bipartite Graphs,” Fifth IEEE International Conference on Data Mining, ICDM pp. 418-425, November, 2005, the contents of which are incorporated herein by reference. Then, the similarity measurement module 102 combines cluster scores 126 for each patient 140-1-140-m to provide a global similarity for each, S_{{x,y}}=t₁*s₁+t₂*s₂+ . . . +wₙ*sₙ, where t₁ . . . tₙ are the weighting coefficient on the factors, sᵢ is the match result of x and y on factor i, and i is between 1 to n.

In this example, the factor clusters 142-1-142-n are categories for the individual nodes, which include a diagnosis code cluster 142-1, e.g., Clinical Classifications Software (CCS); a procedure code (CPT) cluster 142-2, and a drug code (NDC) cluster 142-n. Also, individual factor nodes can indicate symptoms, indicate a temporal logical sequence modeled as factor nodes, or be a very general (e.g., logical) indicator. For example, factor nodes can indicate glucose level as normal, low, or high. In another example, a factor node can indicate the logical sequence“CCS.1 follows with (CPT.2 and NDC.2).” For each cluster 142-1-142-n, the similarity measurement module 102 determines the cluster similarity 124 of requesting patient x with existing patient y 140-1-140-m based on the correlation of factors between the two patients x and y. Optionally, instead of using a weighted familiarity approach to arrive at similarity measurements, a random walk approach as also described by Sun et al. may be used. The similarity measurement module 102 stores 128 the global similarity measure S_{x,y}, e.g., in storage 110, for use by the similarity match module 104.

The similarity match module 104 searches and retrieves and displays 130 similarity scores S_{x,1}-S_{x,m} for similarity matches. Matches may be selected as the top-k similar scores, where k is some number between 1 and m, the number of matched patients. Further, k can be selected, for example, by default or when requested. The similarity match module 104 retrieves and presents 130 the matching similar scores, e.g., displaying 112 the matches for a medical professional, such as a nurse or a doctor. The medical professional can review the displayed results, either individually S_{x,1}-S_{x,m}, or the selected similarity matches. The medical professional may further review the efficacy of the treatment selected and/or the similarity to patient y or the group of patients, for example, and provide feedback 132 based on that review.

The feedback module 106 receives feedback general patient similarity measure incorporating from experts, e.g., including/excluding certain data sources, varying weights for each. So, for example, using a typical GUI, the medical professional can select individual factor nodes or clusters for exclusion in the similarity measure S_{y,z}. Also, the medical professional can adjust both edge weights and factor weights. Based on this feedback 32, the similarity measurement module 102 regenerates the global similarity measures S_{x,1}-S_{x,m} for the patient x.

Thus advantageously, a preferred system 100 handles multiple data sources, incorporating expert feedback to arrive at the best selection of similar patients. The preferred similarity measurement module leverages the flexibility of a preferred factor graph model to model to selectively add/remove additional features or data sources to the consideration. The factor graph model also enables varying weighting coefficients on different features. Optimal weighting coefficients may be determined using a classification problem on all pairs of patients with experts labeling the results positively or negatively.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A system for ordering members of a population, said system comprising:
a similarity measurement module listing members of a population responsive to comparison of member features;
a similarity match module selectively presenting a number of members as the closest matches to one member; and
a feedback module receiving feedback about the presented closest matches.

2. A system as in claim 1, wherein said similarity measurement module graphically maps the relationship between each member and each feature, and said similarity measurement module weights the mapped relationship.

3. A system as in claim 2, wherein said plurality of features are clustered and said similarity measurement module determines for each other member a similarity measure for each cluster for said one member.

4. A system as in claim 3, wherein said similarity measurement module determines a global similarity measure between said one member and said each other member, said global similarity measure being the aggregation of cluster similarity measures for, and indicating the closeness to, said each other member, said similarity measurement module selectively storing a list of matches and corresponding global similarity measures.

5. A system as in claim 4, wherein said similarity list of matches includes a second number of members with corresponding global similarity measures closest to said one member.

6. A system as in claim 4, wherein said similarity match module selects and presents said number of other members having said closest matches from stored said global similarity measures, said weights being adjusted responsive to said feedback.

7. A system as in claim 1 further comprising:
a feature data store storing a plurality of features of said given population; and
a population store storing a list of said population members.

8. A system as in claim 7, wherein said population members are medical patients and said features comprise diagnosis, procedure and drug data for said medical patients.

9. A system as in claim 1, wherein said system further comprises:
a display listing said closest matches; and
a graphical user interface (GUI) displayed on said display, said feedback module interactively receiving said feedback through said GUI.

10. A method of identifying similar members of a population, said method comprising:
receiving a query from an individual, said query identifying a new member of a population;
mapping said new member to a bipartite graph, said bipartite graph including population member nodes connected to factor nodes, said factor nodes being clustered categorically;
providing a global measure of closeness for said each other member to said new member;
selecting for display a plurality of closest other members as being closest matches; and
receiving feedback regarding closeness of the selected members responsive to said display.

11. A method as in claim 10, wherein said population members are medical patients, said factor nodes indicating diagnosis, procedure and drug data for said medical patients, providing a global measure comprises a random walk, and a medical professional is making said query and providing said feedback.

12. A method as in claim 10, further comprising weighting edges connecting population member nodes to factor nodes in said bipartite graph.

13. A method as in claim 12, wherein providing a global measure comprises:
comparing connections in each cluster for said new member with connections of each other member to determine a similarity score, s₁, s₂, . . . , sₙ, for said new member x with each other member y; and
aggregating comparison results for said each other member, aggregated results providing a global measure of closeness to said new member.

14. A method as in claim 13, wherein aggregating comparison results comprises combining similarity scores for said each other member y to provide a global similarity S_{x,y} for each, and selectively storing global similarities for every said other member.

15. (canceled)

16. A computer program product for identifying similar patients, said computer program product comprising a computer usable medium having computer readable program code stored thereon, said computer readable program code comprising:
computer readable program code means for listing existing patients;
computer readable program code means for clustering a plurality of features of said existing patients by category;
computer readable program code means for graphically mapping the relationship between each existing patient and each feature;
computer readable program code means for receiving a query for a new patient;
computer readable program code means for determining a similarity measure indicating similarity between said new patient and each existing patient for each cluster, and listing existing patients members according to similarity;
computer readable program code means for selectively presenting a number of existing patients as closest to said new patient; and
computer readable program code means for receiving feedback about the presented closest patients.

17. A computer program product as in claim 16, wherein said features comprise diagnosis, procedure and drug data for said existing patients.

18. A computer program product as in claim 16, wherein said computer readable program code means for determining comprises computer readable program code means for weighting each similarity measure, and aggregating the weighted similarity measures for said each existing patients, said weights being adjusted responsive to said feedback.

19. A computer program product as in claim 18, wherein said computer readable program code means for determining comprises computer readable program code means for listing a selected number of said existing patients having aggregate measures indicating those patients being closest to said new patient.

20. A computer program product as in claim 18, wherein said computer readable program code means for selectively presenting comprises computer readable program code means for selecting and listing a number of said existing patients having similarity measures indicating closest similarity to said new patient.

21. A computer program product for identifying patients similar to a new patient, said computer program product comprising a computer usable medium having computer readable program code stored thereon, said computer readable program code causing a computer executing said code to:
receive query identifying a new patient;
map said new patient to a bipartite graph, said bipartite graph including patient nodes connected to factor nodes, said factor nodes being clustered categorically, connections being represented as weighted edges;
compare in each cluster connections between said new patient and said factor nodes against connections for other patients;
aggregate comparison results for said each other patient, aggregated results providing a global measure of closeness to said new patient;
select for display a plurality of closest other patients as being closest matches; and
receive feedback regarding closeness of the selected members responsive to said display.

22. A computer program product for routing travel as in claim 21, wherein said factor nodes indicating diagnosis, procedure and drug data for said patients, and a medical professional is making said query and providing said feedback.

23. A computer program product for routing travel as in claim 22, wherein comparing cluster connections comprises determining a similarity score, s₁, s₂, . . . , sₙ, for said new member x with each other member y.

24. A computer program product for routing travel as in claim 23, wherein aggregating comparison results comprises combining similarity scores for said each other member y to provide a global similarity S_{{x,y}} for each, and selectively storing global similarities for every said other member.

25. (canceled)

26. A method of identifying similar members of a population, said method comprising:
receiving a query from an individual, said query identifying a new member of a population;
mapping said new member to a bipartite graph, said bipartite graph including population member nodes connected to factor nodes, said factor nodes being clustered categorically;
weighting edges connecting population member nodes to said factor nodes in said bipartite graph;
providing a global measure of closeness for said each other member to said new member, providing said global measure comprising:
comparing connections in each cluster for said new member with connections of each other member to determine a similarity score, s₁, s₂, . . . , sₙ, for said new member x with each other member y, and
aggregating comparison results for said each other member, aggregated results providing a global measure of closeness to said new member, wherein aggregating comparison results comprises combining similarity scores for said each other member y to provide a global similarity S_{x,y} for each, and selectively storing global similarities for every said other member, and wherein S_{{x}}=t₁*s₁+t₂*s₂+ . . . +wₙ*sₙ, where t₁ . . . tₙ are the weighting coefficient on the factors, sᵢ is the match result of x and y on factor i, and i is between 1 and n;
selecting for display a plurality of closest other members as being closest matches; and
receiving feedback regarding closeness of the selected members responsive to said display, wherein said weighting coefficients are adjusted responsive to said feedback.

27. A computer program product for identifying patients similar to a new patient, said computer program product comprising a computer usable medium having computer readable program code stored thereon, said computer readable program code causing a computer executing said code to:
receive query identifying a new patient from a medical professional;
map said new patient to a bipartite graph, said bipartite graph including patient nodes connected to factor nodes, said factor nodes being clustered categorically and indicating diagnosis, procedure and drug data for said patients, connections being represented as weighted edges;
compare in each cluster connections between said new patient and said factor nodes against connections for other patients, a similarity score, s₁, s₂, . . . , sₙ being determined for said new member x with each other member y;
aggregate comparison results for said each other patient, aggregated results providing a global measure of closeness to said new patient, similarity scores being combined for said each other member y to provide a global similarity S_{{x,y}} for each, and global similarities being selectively stored for every said other member, wherein S_{{x}}=t₁*s₁+t₂*s₂+ . . . +wₙ*sₙ, where t₁ . . . tₙ are the weighting coefficient on the factors, sᵢ is the match result of x and y on factor i, and i is between 1 and n;
select for display a plurality of closest other patients as being closest matches; and receive feedback from said medical professional regarding closeness of the selected members responsive to said display, wherein said weighting coefficients being adjusted responsive to said feedback.
